(19) United States
(12) Patent Application Publication
(10) Pub. No.: US 2009/0178965 A1
(43) Pub. Date: Jul. 16, 2009

(54) Collection and use system of reclaimed water in family life

(76) Inventor: Weiyun Dai, Yichang (CN)

Correspondence Address: Weiyun Dai, Campus508, 223 West Main St, SIU, Salem, WV, 26426, US

(21) Appl. No.: 11/972,176

(22) Filed: Jan. 10, 2008

(51) Int. Cl. B01D 21/30

(52) U.S. Cl. 210/143

(57) ABSTRACT

This equipment organize and simply reconstruct some water equipment which has already being used to recollect the reclaimed water in our daily life and then use the reclaimed water again.

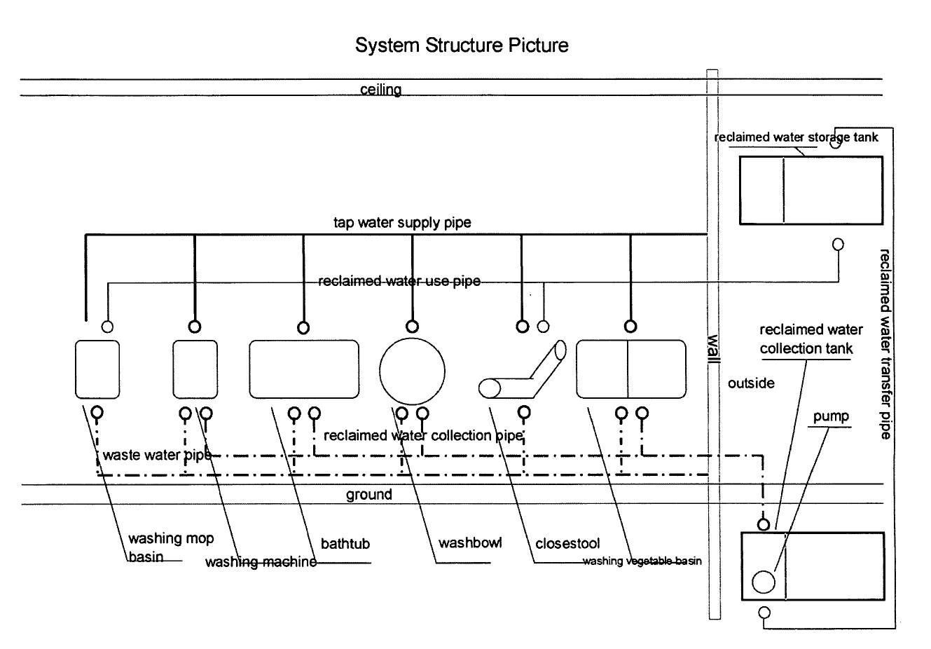

### BRIEF INTRODUCTION

This system is used to collect the reclaimed water which is still clean enough to be used again and to use the reclaimed water which has been collected. The system divided into several parts. First part is used to decide what kind of water is reclaimed water and what kind of water is sewage, and then collect the reclaimed water. The standard of reclaimed water and sewage all depends on the users. Second part is used to storage the reclaimed water. The third part is use the reclaimed water.

### DETAILED INTRODUCTION OF THE SYSTEM

Here is the introduction to the principal of the equipment and the some details about how to put it into practice.

A. The Separation of the Reclaimed Water and the Sewage

Method One

1, The Reclaimed Water and the Sewage

In this introduction, I call the water which has been used to wash clothes, dishware, vegetables, fruit and some other clean things and still can be used in some way the reclaimed water. On the other hand, I call the water which has been used to wash clothes and dishware but are too dirt to use the sewage.

2, Basin

PIC-1 is take the basin A for example to explain how to separate the reclaimed water and the sewage.

C is the waste water pipe. B is the switch of the waste water pipe. B and C have already been designed in nowadays' basin. E is a new part, called reclaimed water collection pipe, which is used to collect the reclaimed water. D is also a new part, and it is also a switch, which is totally the same as B. F is a filter, which is used to clean out the small solid waste in the reclaimed water.

3, The Principal of Separating the Reclaimed Water and Sewage

When you use basin, you should close the switch B and D to keep the clean water in the basin. After you have washed something, you can decide to open one of the switches according to your standard that whether the water is reclaimed water or sewage. If you consider that this water is still clean enough and can be used again, you can open the switch D to make the water flow into the reclaimed water collection pipe. On the contrary, if you think that this water is too dirty to use again, you can directly open the switch B to make it flow away.

3, Some Warnings to Practice

The switches B and D should be differentiated by color, when the basin is made. For example, you can make the switch D green.

The reclaimed water is not only from the basin, but also from some other equipment such as the wash-machine, bathtub and some other equipment which also can be reconstructed as the basin or use the method two to collect reclaimed water.

Method Two

Some people may consider that change another basin is really troublesome. So I find another way to separate the sewage waste water and reclaimed water. PIC-2 is take the basin D for example to explain how to separate the reclaimed water and the sewage.

C is the waste water pipe. A is the switch of the waste water pipe. B is a new part, called reclaimed water collection pipe, which is used to collect the reclaimed water. E is a filter, which is used to clean out the small solid waste in the reclaimed water.

When we want to flow out the waste water, we can switch on the switch A to let the sewage flow out from waste water pipe A. When we want to collect the reclaimed water, we can just switch off the switch A to let the reclaimed water flow into the reclaimed water collection pipe B.

B. The Collection of Reclaimed Water

1, Lay Pipes

In order to make a complete system, the house makers should consider the pipe when they design the houses. The pipes should link reclaimed water pipe and reclaimed water collection tank and some other things.

2, Filter

In order to keep the quality of reclaimed water, after reclaimed water is filtered at the first level filter, we can still set a second level filter. We can also set a U pipe before reclaimed water flow into the reclaimed water collection tank.

PIC-3 is a sketch map of second level filter and the U pipe.

A is the reclaimed water collection tank. B is the end of the reclaimed water pipe. C is the second level filter. And the reclaimed water flow into the reclaimed water collection tank at the exit D. E is the pipe to let the sewage flow away.

a. Filter

The second level filter C is the same as the first level filter. Putting it at the exit D makes the cleaning of the filter more convenient. Both level filters are set to make the solid waste out of the reclaimed water to keep the reclaimed water stay at a proper quality.

b. Flow the Solid Waste Away

After a period of time, there must be some solid waste accumulate on the second level filter, and sometimes the solid waste may so much that the filter can hardly filter out any water. When this thing happens, C is not a filter any more. It is just a pipe which cannot filter water out. Then the water from B will flow the solid waste out at the exit E. And when the solid waste is flow away, the filter again can filter water out.

C. The Transfer and Storage of Reclaimed Water

PIC-4 is the sketch map of the collection, transfer and storage of reclaimed water.

In this sketch map, A is the reclaimed water storage tank of resident (n−1). B is the reclaimed water collection tank of resident (n). C is the reclaimed water collection tank of resident (n). D is the reclaimed water collection tank of resident (n+1). E is the reclaimed water transfer pipe.

Still in this sketch map, we can take the resident (n) for example. His reclaimed water will be collected by the reclaimed water collection pipe and collected at the reclaimed water collection tank C. Then when the C is filled with reclaimed water, an auto system which will be introduced later, including a water pump and an auto water level switch will transfer the reclaimed water up to the reclaimed water storage tank B.

This system should be considered when new house is designed or old house is reconstructed. The cubage of the reclaimed water collection tank should match the cubage of the biggest water container in the house which mostly is wash machine whose cubage is about 50 liter. The cubage of the reclaimed water storage tank should match the cubage of reclaimed water of a whole day which is about 150 liter. In order to make it convenient to wash, both tanks should have covers.

At the top of the reclaimed water collection tank, we should set an insurance pipe. This insurance pipe is linked to the waste water pipe. When the reclaimed water collection tank is full of water, the reclaimed water won't overflow out, but flow into waste water pipe thought the insurance pipe. At the bottom of the reclaimed water collection tank, we should also set a bottom pipe linked with waste water pipe with a valve. In usual, we switch off the valve. When we want to clean the reclaimed water collection tank, we can switch on the valve, and let water flow out to waste water pipe thought the bottom pipe.

D. Pump, Water Level Switch and Auto-Circuit

1. Pump

The pump should suitable for our family use, such as HOB-3900. The height which the pump can step up water should just larger than that of one floor.

2. Water Level Switch

(1). Water Level Switch K1

The water level switch K1 is in the reclaimed water collection tank. PIC-5 is a picture of the sketch map.

In this sketch map, A is the reclaimed water collection tank, B is the pump, C is the drifted ball, D is the linkage stick, E is the shelf of water level switch and K1 is the water level switch.

When the water level in this tank is lower than height h, K1 is off. When the water level is higher than h, the drifted ball will drift to make the linkage stick switch on the K1.

(2) Water Level Switch K2

The water level switch K2 is in the reclaimed water storage tank. PIC-6 is a picture of the sketch map.

Here is a drifted ball and a linkage stick in the tank. When the water level is higher than H, the drifted ball will make the linkage stick switch on the water level switch K2.

3. The Auto-Circuit

PIC-7 is the auto-circuit diagram.

Make the circuit as the sketch map described. When the reclaimed water collection tank is full of water and the reclaimed water storage tank is not full, the switch K1 and K2 will both be on. Then the pump will work to step the water in reclaimed water collection tank up to the reclaimed water storage tank. When the water level in the reclaimed water collection tank is low or the reclaimed water storage tank is full of water, K1 or K2 will be off, and then the pump will stop work.

E. The Use of Reclaimed Water

At the bottom of the reclaimed water storage tank, we should set a reclaimed water use pipe. The use pipe should have exits at urinal, mop washing pond and some other places where reclaimed water can be used. The exits of the use pipe should also have some valves. In our daily lives, when we want to wash the urinal or wash the mop, we can switch on the valve of reclaimed water use pipe to use the reclaimed water to clean them. In this way, we can use some reclaimed water instead of clean water to save water.

In order to make the hydraulic pressure of the reclaimed water keep high while the reclaimed water storage level is not very high, we should keep the diameter of the pipes small.

The Opportunity to Application:

1. How Can We Apply this System

The best time to apply the system is complete the system when we build a new house, either a hall or a villa.

2. Some Basis of Statistics

Take a family of three for example. The medicinal common sense tell us take a person need one time of stool and five times of pees. Everyday we use closetool, which has two parts to deposit water. The cubages of the two parts are 3 L and 6 L. So the cubage of water the family use everyday is 63 L. Then consider that when we wash dishes, mops and so forth, we can still have some reclaimed water. So we can make the cubage of the reclaimed water storage tank 150 L.

This is basin A. It is a little different from our daily use basin. Our daily use basin has only one water pipe. At the connection part of basin and pipe, there is a switch. This basin has two water pipes. At each connection part of basin and pipe, there is switch. In this picture, part C and part E are pipes, and part B and part D are switches. Part F is also a part which may basins have nowadays. It is a filter.

This is basin D. It has only one pipe C and at the connection part of pipe and basin there is a switch E. They are totally the same as basins which are used today. We reconstruct some part of part C. We connect another pipe B to pipe C. Just below the connection part of pipe B and pipe C, we set a switch A there.

Part A is a water tank. Part B is a water pipe with a U pipe part. Part E is the end of pipe B. It is an exit of pipe. We make a hole at the bottom of U pipe and connect a short pipe D there. On the hole, we set a filter C.

This is a side cutaway view of a part of a building. Part A, part B, part C and part D are tanks. E is a pipe connect the bottom of tank C and cover of tank B.

A is a tank, B is the pump, C is the drifted ball, D is the linkage stick, E is a cover and K1 is a switch.

When the water level in this tank is lower than height h, K1 is off. When the water level is higher than h, the drifted ball will drift to make the linkage stick switch on the K1.

A is a tank. D is the cover of tank A. B is a drift ball with a linkage C. K2 is a switch.

When the water level is higher than H, the drifted ball will make the linkage stick switch on the water level switch K2.

This picture is a circuit diagram. There are three switches K, K1, K2 and a pump.

1. A system which consists reclaimed water collection part, reclaimed water collection pipes, reclaimed water collection tank, reclaimed water storage tank, reclaimed water use pipe and an auto circle to transfer the reclaimed water from the collection tank to storage tank.

2. An auto circle which consists two water level switches, a circle and a water pipe to automatically transfer the reclaimed water from collection tank to storage tank.

3. A reclaimed water collection pipe which consists a filter, a U pipe and an insurance pipe.
